(19) United States
(12) Patent Application Publication
(10) Pub. No.: US 2011/0302642 A1
(43) Pub. Date: Dec. 8, 2011

(54) IMAGE FORMING APPARATUS, CONTROL METHOD THEREOF, AND STORAGE MEDIUM

(75) Inventor: Yasutomo TANAKA, Kawasaki-shi (JP)

(73) Assignee: CANON KABUSHIKI KAISHA, Tokyo (JP)

(21) Appl. No.: 13/152,945

(22) Filed: Jun. 3, 2011

(30) Foreign Application Priority Data
Jun. 4, 2010 (JP) 2010-129354

(51) Int. Cl. G06F 21/20

(52) U.S. Cl. 726/7

(57) ABSTRACT

In an image forming apparatus of the present invention, authentication information necessary for a user to log in to the image forming apparatus and address information of a mobile terminal are stored associated with each other, and upon receiving from a mobile terminal a search request for searching for a device with which to establish wireless communication, and the address information of the mobile terminal, it is determined, based on the address information and the stored information, whether the address information is associated with authentication information of the user that has logged in to the image forming apparatus. As a result, if it has been determined that the address information is associated with the authentication information of the user that has logged in to the image forming apparatus, information indicating that the image forming apparatus has been logged in to is transmitted as a response to the search request.

### BACKGROUND OF THE INVENTION

1. Field of the Invention

The present invention relates to an image forming apparatus capable of wireless communication, a control method thereof, and a storage medium.

2. Description of the Related Art

Recently, remarkable development has been achieved in information processing apparatuses capable of wireless communication, and mobile terminals having various functions in addition to a telephone function have been proposed. Some such mobile terminals have, for example, an e-mail transmitting/receiving function, Web browsing function, and function for displaying documents of various formats, such as PDF documents, Word (registered trademark) documents, and PowerPoint (registered trademark) documents.

Due to diversification of mobile terminals, demand has been increasing for printed documents in various formats stored in such mobile terminals, and a technique has been proposed to directly print documents from mobile terminals. For example, Japanese Patent Laid-Open No. 2001-175432 proposes a mobile terminal-use printer cable which is cable-connected to a mobile terminal and an image forming apparatus, converts print data input from the mobile terminal into a data format printable with the image forming apparatus, and outputs the converted print data to the image forming apparatus. Also, in Japanese Patent Laid-Open No. 2002-169665, an image forming apparatus which is connected to a mobile terminal to receive data stored in the mobile terminal, and executes printing according to the data is proposed. Also, in Japanese Patent Laid-Open No. 2003-241911, a data printing system which includes a mobile terminal and a printing apparatus, and prints data output from the mobile terminal with the printing apparatus is proposed. Furthermore, there are known to be techniques using various forms of communication in data communication between a mobile terminal and an image forming apparatus.

However, the above-described conventional techniques have the problem described below. For example, in the case where non-directional wireless communication such as Bluetooth (registered trademark) communication is performed in data communication between a mobile terminal and an image forming apparatus, first, the data-transmitting side (i.e., mobile terminal) searches for a Bluetooth (registered trademark) device. Then, the mobile terminal displays a list of devices found by the search, establishes connection to the device selected by the user, and performs data transfer.

Here, information displayed in the list is the device name arbitrarily set in each device, and in many cases, the device name is a product name by default. That is, if there are a plurality of other devices capable of Bluetooth (registered trademark) communication in a range in which Bluetooth (registered trademark) communication is possible from a mobile terminal, many device names are displayed in the list. Thus, the user needs to recognize the name of the device he/she desires, and it has been difficult to select the desired device unless the user knows the name thereof. As a method to solve this problem, it is possible to identify a desired device by, for example, performing search once, register it, and then use the registered device the next and subsequent times. However, certain procedures are required to connect to an unregistered device, which is troublesome for the user. In this way, with the current techniques, sufficient consideration has not been paid on the use method for printing data from a mobile terminal with an unspecified device.

### SUMMARY OF THE INVENTION

The present invention enables realization of an image forming apparatus that enables a user at a mobile terminal to easily recognize a desired device to which wireless communication is to be established, when a mobile terminal connects to the apparatus via wireless communication, a control method thereof, and a storage medium.

One aspect of the present invention provides an image forming apparatus comprising: a storage unit that stores authentication information necessary for a user to log in to the image forming apparatus and address information of a mobile terminal associated with each other; a receiving unit that receives, from a mobile terminal, a search request for searching for a device with which to establish wireless communication and the address information of the mobile terminal; a determination unit that determines, based on the address information received by the receiving unit and information stored in the storage unit, whether the address information is associated with authentication information of a user that has logged in to the image forming apparatus; and a transmitting unit that, in a case where the determination unit has determined that the address information is associated with the authentication information of the user that has logged in to the image forming apparatus, transmits information indicating that the image forming apparatus has been logged in to as a response to the search request.

Further features of the present invention will be apparent from the following description of exemplary embodiments with reference to the attached drawings.

### BRIEF DESCRIPTION OF THE DRAWINGS

FIG. 1 is a block diagram illustrating a configuration example of a multifunctional peripheral 100 according to an embodiment of the present invention.

FIG. 2 is a block diagram illustrating a configuration example of a mobile terminal 200 having a short-range wireless communication function according to the embodiment of the present invention.

FIG. 3 is a diagram illustrating a configuration example of an image forming system according to the embodiment of the present invention.

FIG. 4 is a diagram illustrating an example of a pre-communication start screen displayed by a display unit of the multifunctional peripheral 100 according to the embodiment of the present invention.

FIGS. 5A and 5B are diagrams illustrating an example of a screen displayed by a display unit of the mobile terminal 200.

FIG. 6 is a flowchart illustrating an example of a processing procedure in an image forming system 300 according to the embodiment of the present invention.

FIG. 7 is a flowchart illustrating a processing procedure from logging in to the multifunctional peripheral 100 to display of the name of a Bluetooth (registered trademark) device in the mobile terminal 200, according to the embodiment of the present invention.

FIG. 8 is a diagram illustrating a table stored in the multifunctional peripheral 100 according to the embodiment of the present invention, the table associating user login accounts with BD addresses of the mobile terminals 200 in possession of the account holders.

FIG. 9 is a diagram illustrating an example screen of the Bluetooth (registered trademark) device search results displayed by the display unit of the mobile terminal 200 according to the embodiment of the present invention.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

Configuration of Image Forming Apparatus

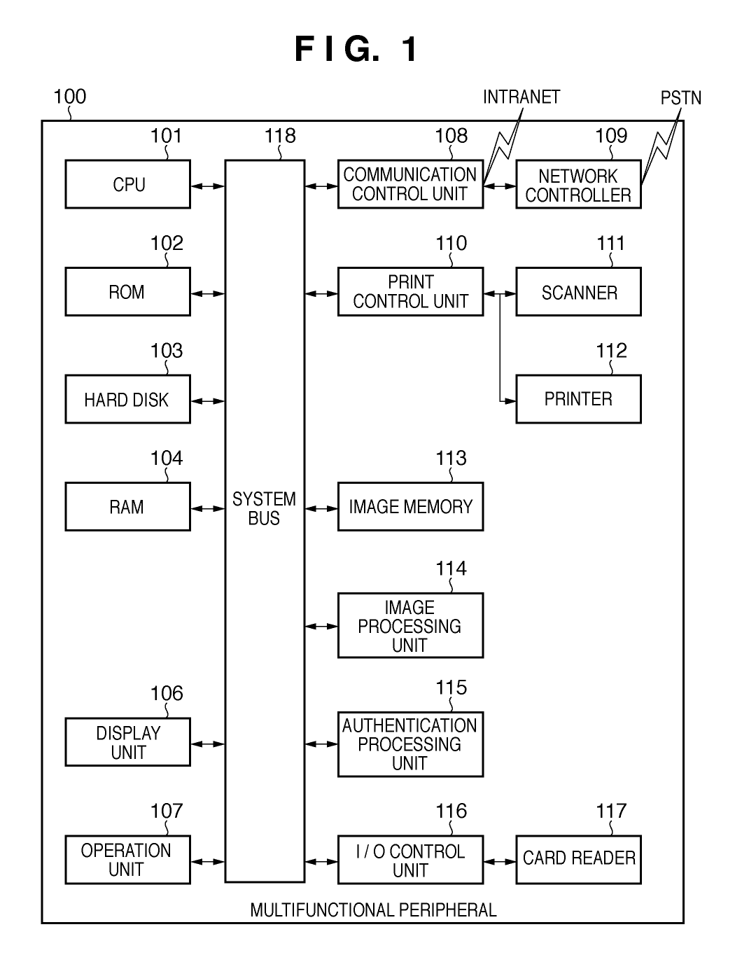

First, with reference to FIG. 1, the configuration of an image forming apparatus according to an embodiment of the present invention is described. In the present embodiment, although a multifunctional peripheral 100 is described as an example of the image forming apparatus, the present invention can be applied to image forming apparatuses capable of wireless communication with a mobile terminal and the like. The multifunctional peripheral 100 includes a CPU 101 as a central processing unit, a ROM 102, a hard disk 103 and a RAM 104. The ROM 102 stores various information such as driving conditions, management data and the like of the units of the apparatus connected to a system bus 118. The RAM 104 stores data necessary for the operation of the multifunctional peripheral 100. The CPU 101 executes various processing according to control programs stored in the ROM 102, the hard disk 103 and the like.

The multifunctional peripheral 100 further includes a display unit 106, an operation unit 107, a communication control unit 108, a print control unit 110, an image memory 113, an image processing unit 114, an authentication processing unit 115, and an I/O control unit 116. The display unit 106 displays various information such as driving conditions, the apparatus's state, input information or the like. The operation unit 107 includes hard keys such as a numerical keypad and a start key for performing operations for inputting settings, commands and the like by the user, and a softkey such as a touch panel in the display unit 106.

The communication control unit 108 controls transmission and reception of document data containing image data and control commands, by connecting to an intranet or the Internet via a wireless or wired network. Also, the communication control unit 108 includes an unshown wireless communication control unit, and is configured to be capable of wireless communication with a mobile terminal. As a communication method, Wi-Fi, Bluetooth (registered trademark) and the like may be used.

A network controller 109 connects to a PSTN (public switched telephone network) and executes a prescribed line control at the time of outgoing/incoming communication, and controls line connection or disconnection therefrom. The multifunctional peripheral 100 modulates/demodulates image data, control signals and the like with an incorporated modem device, and executes facsimile transmission/reception via the network controller 109. A scanner 111 reads image data by performing photoelectric conversion on reflected light that corresponds to the image of light irradiated on the original document, and transmits, duplicates, or saves the image data via the print control unit 110.

The image processing unit 114 encodes image data to be transmitted by data compression. The image processing unit 114 also expands received image data to decode the data, and converts received image data into printable image data, for example. The image processing unit 114 also converts image data to be saved into data in an appropriate format or a format designated by the user (e.g., PDF format). Also, the image processing unit 114 performs image correction processing according to a photoresponsive characteristic of the scanner 111, sender variation, or the like. Furthermore, the image processing unit 114 performs image optimization processing of converting image data into image data suitable for a write characteristic and the like of a printer 112, and the like, upon request.

The authentication processing unit 115 performs print job authentication in addition to authentication of the users and work groups. A card reader 117 uses short-distance wireless communication such as NFC (near field communication) to exchange commands and data with a contactless IC card, and transmit or provide a notice of data such as user information via the I/O control unit 116. The card reader 117 includes a portion above which a card (not shown) is held. The system bus 118 has connected thereto the CPU 101, ROM 102, hard disk 103, RAM 104, display unit 106, operation unit 107, communication control unit 108, print control unit 110, image memory 113, image processing unit 114 and I/O control unit 116.

Accordingly, the multifunctional peripheral 100 has a transfer function of performing facsimile communication for transmitting read image data and performing data transfer to a document management server computer, and a duplication function of performing printing based on read image data. In addition, the multifunctional peripheral 100 includes a receiving and printing function of receiving reception image data by fax and a printing function of receiving print data from a client computer and printing the data. That is, the multifunctional peripheral 100 functions not only as a copy machine, but also as a facsimile machine, a printer, and a scanner. Note that other than the electrophotographic system, other systems such as an ink-jet system, thermal head system, and dot impact system may be applied to the printer 112.

Configuration of Mobile Terminal

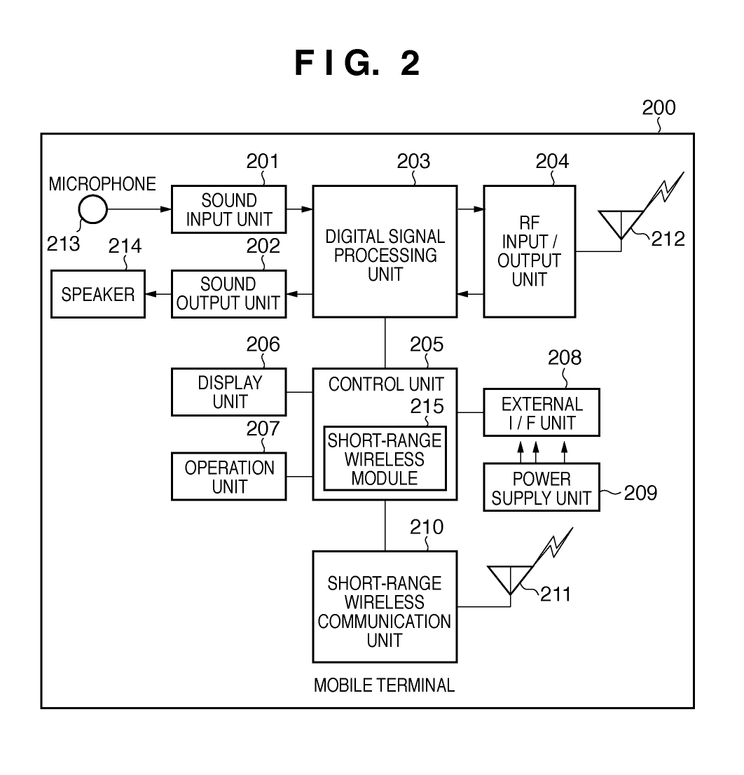

Next, with reference to FIG. 2, the configuration of a mobile terminal 200 having a short-range wireless communication function of the present embodiment will be described. Note that in the present embodiment, although the following configuration is described as an example, the present invention can be applied in various forms to any device capable of information communication, and is not especially limited to the present embodiment.

The mobile terminal 200 includes a sound input unit 201, a sound output unit 202, a digital signal processing unit 203, a RF input/output unit 204, a control unit 205, a display unit 206, an operation unit 207, an external I/F unit 208, a power supply unit 209, a short-range wireless communication unit 210, antennas 211 and 212, a microphone 213 and a speaker 214. As shown in FIG. 2, the digital signal processing unit 203, the display unit 206, the operation unit 207, the external I/F unit 208 and the short-range wireless communication unit 210 are connected to the control unit 205.

The control unit 205 is a main portion for realizing functions of the mobile terminal 200, and is configured from a CPU, EEPROM, Flash, SRAM and the like, which are not shown. Furthermore, in the present embodiment, the control unit 205 includes a short-range wireless module 215 for exchanging commands and data with the short-range wireless communication unit 210. The digital signal processing unit 203 is connected to the sound input unit 201 to which the microphone 213 is connected, the sound output unit 202 to which the speaker 214 is connected, and the RF input/output unit 204 to which the antenna 212 is connected. Also, the digital signal processing unit 203 performs encoding of digital sound signals, decoding to digital sound signals, and the like.

The sound input unit 201 converts analog sound signals received from the microphone 213 to digital signals. The sound output unit 202 controls the speaker 214 to output the received digital sound signals as sound. The RF input/output unit 204 performs high-frequency transmission/reception. The short-range wireless communication unit 210 is connected to the short-range wireless module 215 of the control unit 205, and exchanges data and the like with an external apparatus via the antenna 211. The short-range wireless module 215 is incorporated in the control unit 205, and in the case where Bluetooth (registered trademark) communication is used for short-range wireless communication, controls communication function by exchanging commands.

The display unit 206 displays information to the user, and is configured from an LCD driver, an LCD display device, and the like. The operation unit 207 is a user interface, and is used for the user to input information to the mobile terminal 200. The power supply unit 209 supplies necessary electric power to each block from a battery power source.

Configuration of Image Forming System

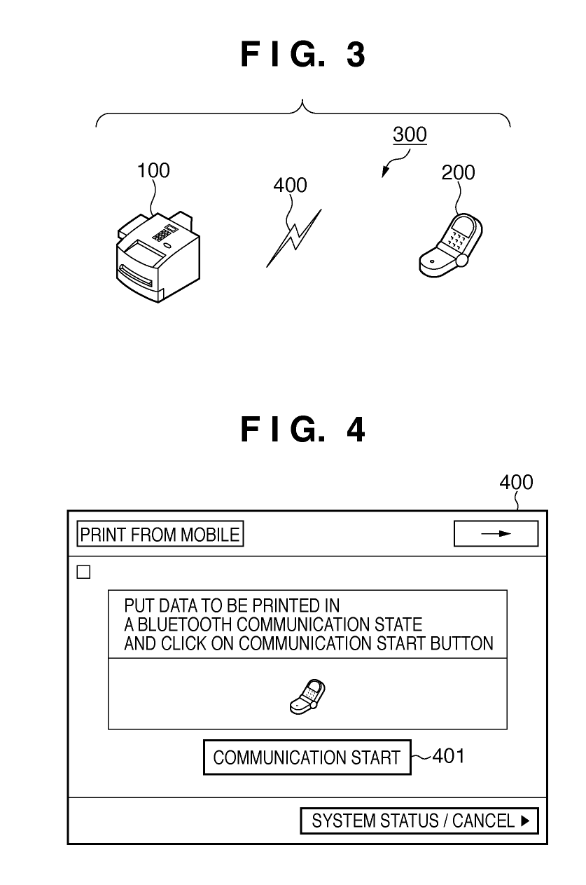

Next, with reference to FIG. 3, the configuration of an image forming system 300 according to the present embodiment is described. The image forming system 300 is configured from the multifunctional peripheral 100 and the mobile terminal 200. As shown in FIG. 3, a mobile phone is shown as an example of the mobile terminal 200 that a general user uses. However, the present invention is not limited to the mobile phone, and other mobile terminals capable of short-range communication may be used. Also, there is no limitation to the multifunctional peripheral 100, and other image forming apparatuses such as a printer and fax may be used. Also, reference numeral 400 denotes wireless communication, which includes wireless communication according to Wi-Fi, Bluetooth (registered trademark) and the like. The present embodiment is described taking Bluetooth (registered trademark) communication as an example.

Screen Example

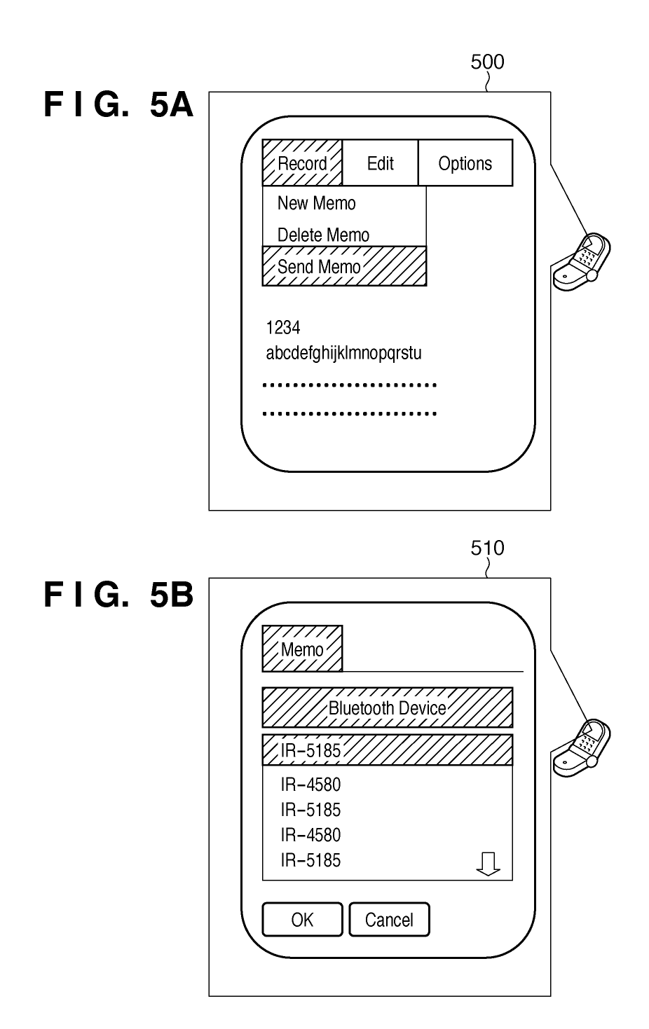

Next, with reference to FIGS. 4 and 5, general screens displayed by the display unit 106 of the multifunctional peripheral 100 and the display unit 206 of the mobile terminal 200 are described. FIG. 4 shows a screen 400 displayed by the display unit 106 of the multifunctional peripheral 100. The screen 400 includes a Communication Start button 401 for the multifunctional peripheral 100 and the mobile terminal 200 to start communication. By clicking the Communication Start button 401, the multifunctional peripheral 100 becomes capable of Bluetooth (registered trademark) communication.

FIGS. 5A and 5B show screens 500 and 510 displayed by the display unit 206 of the mobile terminal 200. The screen 500 is an example of a screen for selecting a menu when transmitting a document saved in the mobile terminal 200 to the multifunctional peripheral 100 by Bluetooth (registered trademark) communication. In the screen 500, by selecting “Send Memo” from the menu, wireless communication is started.

The screen 510 is an example of a screen displaying devices found as a result of a search, when a document saved in the mobile terminal 200 is to be sent to the multifunctional peripheral 100 by Bluetooth (registered trademark) communication. The screen 510 shows, for example, the results of the search for devices for performing Bluetooth (registered trademark) communication performed by the mobile terminal 200 after “Send Memo” is selected in the screen 500. The screen 510 is an example of the screen displayed when a plurality of Bluetooth (registered trademark) devices are found, and by selecting a desired Bluetooth (registered trademark) device, printing is executed with the desired multifunctional peripheral 100.

However, as shown in the screen 510, generally, only the names of the devices found by the search are displayed in a list. In such a situation, the user is required to recognize the name of the device he/she desires, and if the user does not recognize the name, it is impossible to identify the desired device. Therefore, in the present embodiment, the image forming apparatus is configured such that the user can easily recognize the device he/she desires in the display of the list as described above. Specific control is described below in detail.

Processing Procedure

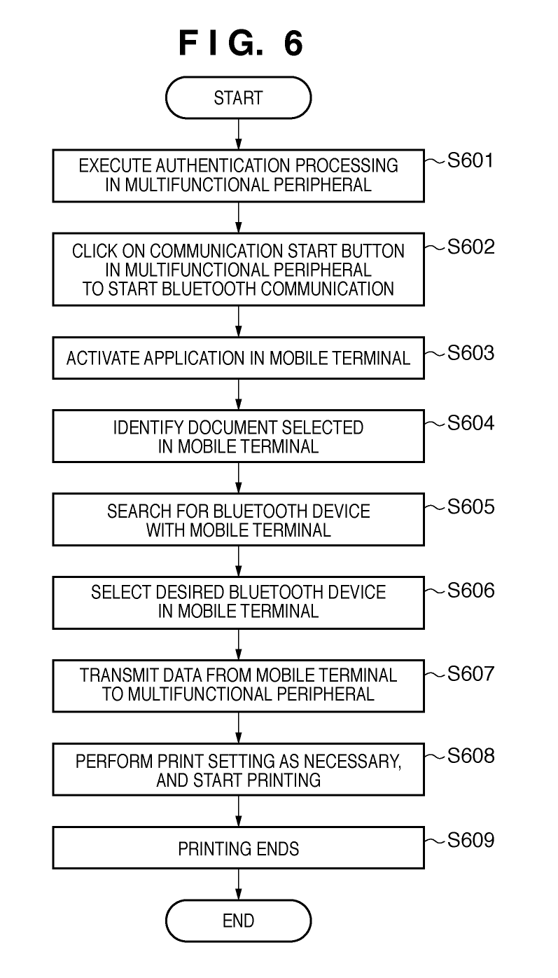

Next, with reference to FIG. 6, the processing procedure between the multifunctional peripheral 100 and the mobile terminal 200 according to the present embodiment is described. In the processing described below, the CPU 101 of the multifunctional peripheral 100 or the control unit 205 of the mobile terminal 200 performs control. Note that the user who is to print print data saved in the mobile terminal 200 with the multifunctional peripheral 100 goes to the front of the multifunctional peripheral 100 while carrying the mobile terminal 200, and logs in to the multifunctional peripheral 100 in order to use a Bluetooth (registered trademark) communication function of the multifunctional peripheral 100.

When a user starts a login procedure, in step S601, the CPU 101 performs authentication of the user with the authentication processing unit 115, and if the authentication result is successful, allows the user to log in to the multifunctional peripheral 100. The authentication may be performed by inputting a password through the operation unit 107, or card authentication by the card reader 117. Furthermore, the CPU 101 causes the screen 400 to be displayed by the display unit 106 of the multifunctional peripheral 100 after authentication processing. The CPU 101 detects the Communication Start button 401 having been clicked via the screen 400 displayed by the display unit 106. Next, in step S602, the CPU 101 causes the Bluetooth (registered trademark) communication to be started through the control performed by the communication control unit 108 that functions as a wireless communication unit.

Next, according to the user's operation, the control unit 205 of the mobile terminal 200 activates an application in step S603 so as to identify the print data saved in the mobile terminal 200. Note that in the case of a mobile terminal 200 having a mechanism for identifying the print data by displaying the data list from the menu of the mobile terminal 200 without activating an application dedicated to print data, it is not necessary to activate the application.

Next, in step S604, the control unit 205 identifies the document targeted for Bluetooth (registered trademark) communication according to the user's operation. When the document selected by the user is identified, the control unit 205 causes Bluetooth (registered trademark) communication to be started with the short-range wireless communication unit 210.

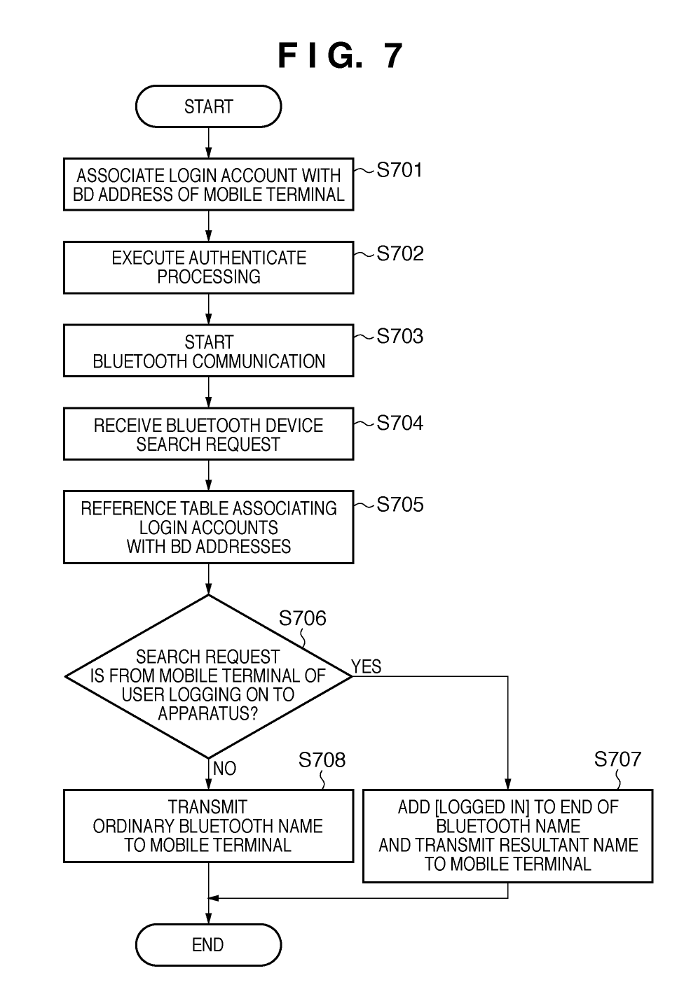

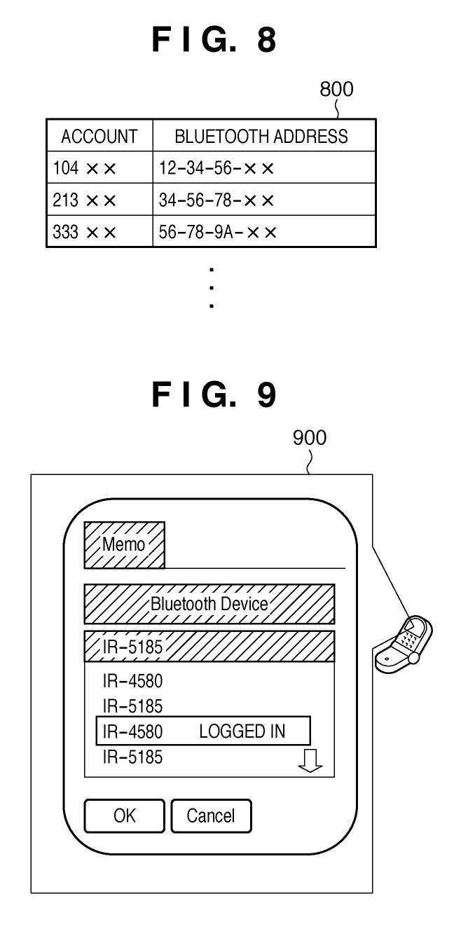

Next, in step S605, the control unit 205 searches for a Bluetooth (registered trademark) device located within a communicable distance. Then, the control unit 205 displays a list of device names such as the screen 510 by the display unit 206 in order to determine the Bluetooth (registered trademark) device to connect to among the Bluetooth (registered trademark) devices found by the search, and prompts the user to select one. Here, in the present embodiment, as in a screen 900 shown in FIG. 9, a character string indicating “logged in” is added to the Bluetooth (registered trademark) name of the multifunctional peripheral 100 to which the user has been logged in. Accordingly, the user can easily recognize the device that the user has been logged in to as shown in FIG. 9, and thus can easily find a desired device. Note that the details of the method of displaying device names are described later with reference to FIGS. 7 and 8.

In step S606, the control unit 205 selects a desired multifunctional peripheral from the list displayed by the display unit 206 according to the user's operation. Furthermore, the control unit 205 identifies the selected Bluetooth (registered trademark) device, and starts connection to that device with the short-range wireless communication unit 210. Next, in step S607, the control unit 205 transmits data to the multifunctional peripheral 100 from the short-range wireless communication unit 210. In step S608, when the CPU 101 of the multifunctional peripheral 100 has received the data transmitted from the mobile terminal 200 in step S607, the CPU 101 displays a screen by the display unit 106, performs print setting as necessary, and starts printing. After that, in step S609, the CPU 101 ends processing after detecting end of printing.

Method of Displaying Device Names

Next, with reference to FIGS. 7 and 8, the method of displaying Bluetooth (registered trademark) device names in the mobile terminal 200, which is a characteristic point of the present invention, is described in further detail. FIG. 7 shows a flowchart illustrating a processing procedure of the multifunctional peripheral 100 in the control for displaying Bluetooth (registered trademark) device names. Note that the processing described below is executed by the CPU 101 of the multifunctional peripheral 100 executing programs stored in the memory such as a ROM. The flowchart is started by the user registering his/her account to the multifunctional peripheral 100. Note that the user registers, when registering his/her own account, the Bluetooth (registered trademark) device address (herein after referred to as a “BD address”) of the mobile terminal 200 in his/her possession as well. Note that the BD address is a wireless communication address for wireless communication of the mobile terminal, and is an address unique to each mobile terminal.

When a user has registered a user account for using the multifunctional peripheral 100 in advance, in step S701, the CPU 101 stores a table defined by associating the login account of the user with the BD address of the mobile terminal in the hard disk 103. FIG. 8 shows an example of the table stored in step S701. A table 800 shown in FIG. 8 is a table defined by associating a user account with the BD address of the mobile terminal 200 of the holder of that account, and is stored in the hard disk 103 or the like. Note that the table is updated when a user has performed account registration.

Next, when a user has started processing to log in to the multifunctional peripheral 100, in step S702, the CPU 101 executes authentication processing with the authentication processing unit 115, and if the authentication result is successful, allows the user to log in to the multifunctional peripheral 100, and causes the screen 400 to be displayed by the display unit 106. Next, in step S703, when the CPU 101 has detected that the Communication Start button 401 has been clicked, the CPU 101 starts Bluetooth (registered trademark) communication with the communication control unit 108 that functions as a wireless communication unit. Here, the multifunctional peripheral 100 becomes capable of receiving a search request from another Bluetooth (registered trademark) device. Thereafter, in step S704, the CPU 101 receives the search request from the mobile terminal 200 through the Bluetooth (registered trademark) communication started in step S703.

Here, the search request is a request to search for a device with which the mobile terminal 200 is to establish Bluetooth (registered trademark) communication. Note that since Bluetooth (registered trademark) communication is non-directional wireless communication, the search request is received by all devices that are located within the communication range of the Bluetooth (registered trademark) communication centered on the mobile terminal 200 and capable of Bluetooth (registered trademark) communication. When the CPU 101 has received a search request, in step S705 it references the table 800 associating login accounts with BD addresses.

Next, in step S706, the CPU 101 determines whether the mobile terminal 200 that has transmitted the search request is the mobile terminal 200 of the user who is currently logged in to the multifunctional peripheral 100. As a determination method, since the search request from the mobile terminal 200 includes the BD address of the mobile terminal 200, the BD address is used as a search key to retrieve the same BD address defined in the table 800. Furthermore, if the same BD address is retrieved from the table 800, it is determined whether the account associated with the BD address is currently logged in to. Note that the determination made here is for determining, for example, whether the user account authenticated by the authentication processing unit 115 in step S702 is the same as the account associated with the BD address. Here, if it is determined that the search request is from the mobile terminal 200 of the user who is logged in, the processing proceeds to step S707, and if not, the processing proceeds to step S708.

In step S707, the CPU 101 adds a character string indicating “logged in” to the Bluetooth (registered trademark) name of the multifunctional peripheral 100, such as the character string “logged in”, to the default Bluetooth (registered trademark) name, and transmits the name to the mobile terminal 200 as a response to the search request. In contrast, in step S708, the CPU 101 transmits an ordinary Bluetooth (registered trademark) name to the mobile terminal 200 as a response to the search request. Thereafter, the procedure proceeds to the processing in step S606 in FIG. 6.

Accordingly, as shown in the screen 900, when the names of the devices found due to the search request are displayed in a list, a character string indicating “logged in” is added to the device name of the multifunctional peripheral to which the user is logged in. As a result, the user can easily recognize the device to which he/she is logged in in the search for Bluetooth (registered trademark) devices, and thus can easily select the device to which the user is logged in.

Note that the foregoing embodiment can be modified in various manners. For example, the present invention may be applied to a system configured from a plurality of devices, or an apparatus configured from a single device. Also, in the foregoing embodiment, although the description is made focusing on the communication between the mobile terminal 200 and the multifunctional peripheral 100, the present invention is not limited to this. For example, the present invention can be applied to communication between multifunctional peripherals 100, that between mobile terminals 200, or that between a mobile terminal 200 and a car navigation system. Also, the present invention may be used for communication between an information processing apparatus such as a personal computer and a multifunctional peripheral. That is, the present invention is effective in any situation in which a plurality of information processing apparatuses of the same type are found as connection candidates for wireless communication, and has an effect of making it easier to identify the information processing apparatus to be the communication target.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium)

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-129354 filed on Jun. 4, 2010, which is hereby incorporated by reference herein in its entirety.

What is claimed is:

1. An image forming apparatus comprising:
a storage unit that stores authentication information necessary for a user to log in to the image forming apparatus and address information of a mobile terminal associated with each other;
a receiving unit that receives, from a mobile terminal, a search request for searching for a device with which to establish wireless communication and the address information of the mobile terminal;
a determination unit that determines, based on the address information received by the receiving unit and information stored in the storage unit, whether the address information is associated with authentication information of a user that has logged in to the image forming apparatus; and
a transmitting unit that, in a case where the determination unit has determined that the address information is associated with the authentication information of the user that has logged in to the image forming apparatus, transmits information indicating that the image forming apparatus has been logged in to as a response to the search request.

2. The image forming apparatus according to claim 1, further comprising:
an authentication unit that uses the authentication information to execute authentication processing for a user who is to log in to the image forming apparatus; and
a wireless communication unit that starts wireless communication in a case where an authentication result by the authentication unit is successful.

3. The image forming apparatus according to claim 1,
wherein the transmitting unit adds, to an apparatus name of the image forming apparatus, information indicating that the image forming apparatus has been logged in to, and transmits the resultant apparatus name as a response to the search request.

4. The image forming apparatus according to claim 1,
wherein in a case where the determination unit has determined that the address information is not associated with the authentication information of the user that has logged in to the image forming apparatus, the transmitting unit transmits the apparatus name of the image forming apparatus as a response to the search request.

5. The image forming apparatus according to claim 1,
wherein the determination unit includes a retrieving unit that retrieves address information stored in the storage unit by using the address information received by the receiving unit as a retrieval key, and
the determination unit determines, in a case where the retrieving unit has retrieved the address information received by the receiving unit, whether authentication information associated with the address information is the same as the authentication information of the user that has logged in to the image forming apparatus.

6. The image forming apparatus according to claim 1,
wherein the information transmitted by the transmitting unit indicating that the image forming apparatus has been logged in to is a character string indicating that the image forming apparatus has been logged in to.

7. The image forming apparatus according to claim 1,
wherein the wireless communication is Bluetooth (registered trademark) communication, and
the address information is a unique Bluetooth (registered trademark) device address in Bluetooth (registered trademark) communication.

8. A control method of an image forming apparatus including a storage unit that stores authentication information necessary for a user to log in to the image forming apparatus and address information of a mobile terminal associated with each other, the method comprising:
a receiving unit receiving from a mobile terminal a search request for searching for a device with which to establish wireless communication, and the address information of the mobile terminal;
a determination unit determining, based on the address information received in the receiving step and information stored in the storage unit, whether the address information is associated with authentication information of the user that has logged in to the image forming apparatus; and
a transmitting unit transmitting, in a case where it has been determined in the determination step that the address information is associated with the authentication information of the user that has logged in to the image forming apparatus, information indicating that the image forming apparatus has been logged in to as a response to the search request.

9. A storage medium storing a program for causing a computer to execute the control method of an image forming apparatus according to claim 8.
